(19) United States
(12) Patent Application Publication
(10) Pub. No.: US 2026/0356092 A1
(43) Pub. Date: Nov. 12, 2026

(54) INKJET HEAD, INK DISCHARGE METHOD, AND INKJET RECORDING APPARATUS

(71) Applicant: Konica Minolta, Inc., Tokyo (JP)

(72) Inventors: Takuma SHIBATA, Hachioji-shi, Tokyo (JP); Kumi KOBAYASHI, Kunitachi-shi, Tokyo (JP)

(21) Appl. No.: 19/515,329

(22) PCT Filed: Aug. 27, 2024
(86) PCT No.: PCT/JP2024/030504

§ 371 Date: Feb. 27, 2026

(30) Foreign Application Priority Data
Sep. 4, 2023 (JP) 2023-142967

(51) Int. Cl. B41J 2/045; B41J 2/14

(52) U.S. Cl. CPC B41J 2/04588; B41J 2/04573; B41J 2/04581; B41J 2/14201

(57) ABSTRACT

Provided are an inkjet head, an ink discharge method, and an inkjet recording apparatus, which enable discharging of ink having a high viscosity in a more easy and stable manner. This inkjet head comprises a nozzle (N), a pressure chamber (C) that is in communication with the nozzle (N), and a pressure application part (E) that applies pressure fluctuations to ink within the pressure chamber (C). The inkjet head has a structure that has a break up Q factor, which is expressed as πfpφ²/(8η) using a nozzle diameter φ and a resonance frequency f with respect to the ink, of 0.37 or more, when the ink protruding out of the nozzle (N) upon receiving the pressure fluctuations by the pressure application part (E) has a viscosity η of 100 mPa·s and a density ρ of 1080 kg·m⁻³.

### TECHNICAL FIELD

The present disclosure relates to an inkjet head, an ink discharge method, and an inkjet recording apparatus.

### BACKGROUND ART

Inkjet heads can discharge various kinds of ink. Ink differs in density and viscosity depending on its components and the like. Therefore, inkjet heads may have a structure in which the ink can appropriately fly and land according to the ink.

Patent Literature 1 discloses a technique in which, in order to discharge high-viscosity ink at high speed in a stable manner, a diaphragm that applies pressure fluctuation to the ink has a concave-convex structure in which the thickness is locally thickened. Patent Literature 2 discloses a technique in which a nozzle plate has a structure in which the relationship between the size of a nozzle and the size of a pressure chamber is limited.

### CITATION LIST

### Patent Literature

Patent Literature 1: Japanese Unexamined Patent Publication No. 2021-74946

Patent Literature 2: Japanese Patent No. 5659198

### SUMMARY OF INVENTION

### Technical Problem

However, the conventional technologies have a problem in that the structure and the manufacturing process are complicated, which leads to an increase in labor and cost.

An object of the present disclosure is to provide an inkjet head, an ink discharge method, and an inkjet recording apparatus that can discharge high-viscosity ink more easily and stably.

### Solution to Problem

In order to achieve the above object, the present disclosure is an inkjet head including:
a nozzle;
a pressure chamber that communicates with the nozzle; and
a pressurizer that applies a pressure fluctuation to an ink in the pressure chamber,
wherein the inkjet head has a structure in which in a case where a viscosity η of the ink that runs out from the nozzle by the pressurizer applying the pressure fluctuation thereto is 100 mPa·s, and a density ρ thereof is 1,080 kg·m⁻³, a breakup Q value that is expressed as πfρφ²/(8η) using a nozzle diameter (and a resonant frequency f is 0.37 or more with respect to the ink.

### Advantageous Effects of Invention

According to the present disclosure, there is an effect of an inkjet head capable of more easily and stably discharging high-viscosity ink.

### BRIEF DESCRIPTION OF THE DRAWINGS

FIG. 1A It is a perspective view for explaining an inkjet head of the present embodiment.

FIG. 1B It is a view for explaining the shape of a pressure chamber.

FIG. 1C It is a view for explaining the shape of the pressure chamber.

FIG. 1D It is a view for explaining the shape of the pressure chamber.

FIG. 2A It is a view for explaining a state of ink according to pressure fluctuation in the pressure chamber.

FIG. 2B It is a view for explaining the state of ink according to pressure fluctuation in the pressure chamber.

FIG. 2C It is a view for explaining the state of ink according to pressure fluctuation in the pressure chamber.

FIG. 3A It is a view for explaining the state of ink according to pressure fluctuation in the pressure chamber.

FIG. 3B It is a view for explaining the state of ink according to pressure fluctuation in the pressure chamber.

FIG. 4 It is a table showing change in breakup Q value with respect to a nozzle diameter and an AL of an inkjet head, and the result of actual separation of ink droplets.

FIG. 5 It is a block diagram showing a functional configuration of an inkjet recording apparatus.

FIG. 6A It shows an example of a waveform pattern of a first drive signal to be applied to a piezoelectric member at the time of ink discharge.

FIG. 6B It shows an example of a waveform pattern of a second drive signal to be applied to a piezoelectric member at the time of ink discharge.

FIG. 6C It shows an example of a waveform pattern of a third drive signal to be applied to a piezoelectric member at the time of ink discharge.

FIG. 7A It shows the flight speed of a main droplet and the length of a tail extending from the main droplet, according to the waveform pattern of the first drive signal.

FIG. 7B It shows the flight speed of the main droplet and the length of the tail extending from the main droplet, according to the waveform pattern of the first drive signal.

FIG. 8A It shows the flight speed of a main droplet and the length of a tail extending from the main droplet, according to the waveform pattern of the second drive signal.

FIG. 8B It shows the flight speed of a main droplet and the length of a tail extending from the main droplet, according to the waveform pattern of the third drive signal.

FIG. 8C It shows the flight speed of the main droplet and the length of the tail extending from the main droplet, according to the waveform pattern of the third drive signal.

### DESCRIPTION OF EMBODIMENTS

Hereinafter, an embodiment will be described with reference to the drawings.

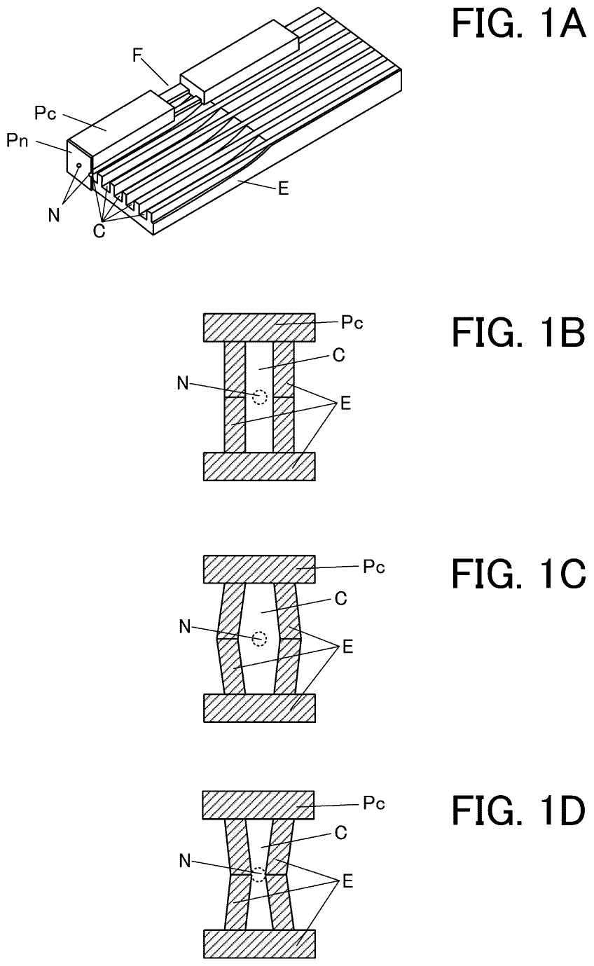

FIG. 1A to FIG. 1D are views for explaining an inkjet head 1 according to the present embodiment. As shown in the perspective view of FIG. 1A, the inkjet head 1 has a substrate of a piezoelectric member E. The piezoelectric member E has recesses extending in parallel. The recesses are pressure chambers C (channels) through which ink flows. The recesses are covered from above by a cover plate Pc, only part of which is shown. The cover plate Pc has a common channel F for supplying ink to the pressure chambers C. The piezoelectric member E is electromechanical conversion element(s) that deform when a voltage is applied thereto, and face adjacent pressure chamber(s) C and are interposed between not-shown electrodes. The electrodes may be covered with a film that does not react with the ink. The electrodes are connected to a not-shown wiring. The piezoelectric members E and the electrodes form a pressurizer. A nozzle plate Pn having a nozzle(s) N is positioned at the leading ends of the pressure chambers C. Only a portion of the nozzle plate Pn corresponding to the cover plate Pc is shown. The nozzle N communicates with the pressure chamber C.

FIG. 1B is a section of the pressure chamber C in a reference state. The section is perpendicular to the axis direction of the nozzle N. As shown in FIG. 1C, when the pressure chamber C expands in response to the deformation, the ink pressure decreases. As shown in FIG. 1D, when the pressure chamber C compresses in accordance with the deformation, the ink pressure increases. The electrodes may be positioned such that, for example, the piezoelectric member E deforms in a shear mode, but this is not a limitation,

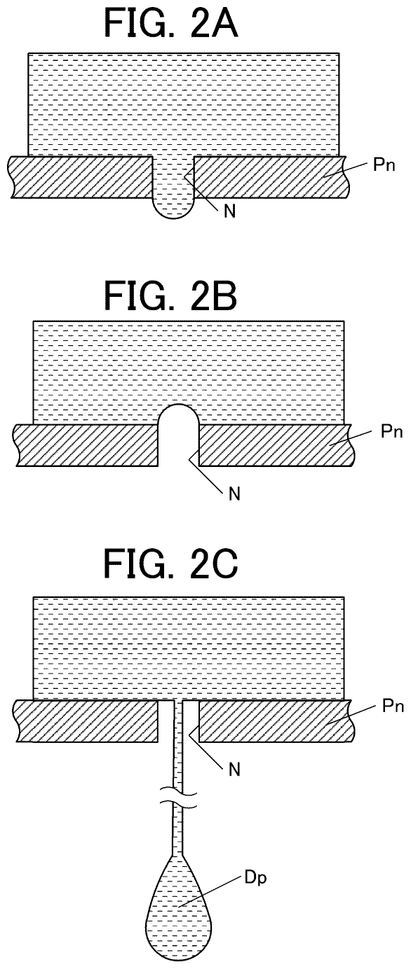

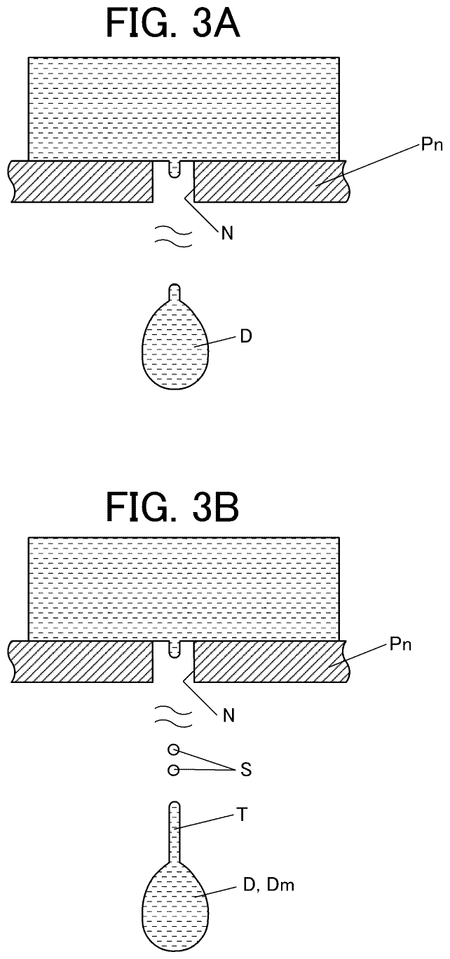

FIG. 2A to FIG. 2C, FIG. 3A and FIG. 3B are views for explaining a state of ink according to pressure fluctuation in the pressure chamber C.

As shown in FIG. 2A, when the ink pressure increases, the ink is pushed out from the nozzle N that is present in the extending direction of the pressure chamber C and communicates with the pressure chamber C. As shown in FIG. 2B, when the ink pressure decreases, the ink is pulled back from the nozzle N to the pressure chamber C. The pressure increase and the pressure decrease can be appropriately combined. The ink to which the pressure fluctuation is applied by an appropriate pressure application pattern partly pops out from the inside of the pressure chamber C and flies. The pressure fluctuation includes push ejection in which the ink is first pressurized and then depressurized, and pull ejection in which the ink is first depressurized and then pressurized.

As shown in FIG. 2C, at the beginning when an ink liquid mass Dp is extruded from the nozzle N, the extruded ink liquid mass Dp and the ink in the pressure chamber C are connected to each other. In accordance with the pressure application pattern, a force for pulling back the ink to the pressure chamber C is appropriately applied to the ink, and thus, as shown in FIG. 3A, the leading portion of the pushed-out ink is appropriately separated from the ink in the pressure chamber C, and the separated ink becomes an independent droplet D.

In a case where the ink liquid mass Dp is not appropriately cut, a long tail T may be generated in the droplet D, and landing positions of the droplet D and the tail T on a medium may be shifted from each other. Alternatively, as shown in FIG. 3B, a long tail T may be further shredded. The shredded microdroplets S (satellites) may have different landing positions with respect to the main droplet Dm or may adhere to unintended positions. In particular, in a case where the distance (interval) between a nozzle opening surface including an opening of the nozzle N and a surface (landing surface) of a recording medium is large, the microdroplets S tend to decelerate due to relatively large air resistance while flying, or the tail T tends to be carried away by the flow of the air. Accompanying this, the shift of the landing positions is likely to increase between the main droplet Dm and the microdroplet S, the tail T, and the like. In the present embodiment, the distance between the opening surface and the landing surface being large means that the distance is larger than 1 mm, and particularly means that the distance is equal to or larger than 2 mm. In the case where the distance is large as described above, the susceptibility to the effect of the air resistance or the air flow also depends on the flight speed of the main droplet Dm. In the case where the distance is large, it is preferable that the flight speed of droplets is at least 4 m/s. The flight speed depends on the amplitude of a drive signal (drive pulse) for discharging ink. A specific waveform pattern of the drive signal will be described later.

As the viscosity of the ink is higher, the ink is less likely to be cut. Therefore, in a case of discharging high-viscosity ink, it requires an inkjet head structure and/or a pressure application pattern to more easily cut ink than normal ink. In the present embodiment, the high viscosity is a level of viscosity as a liquid, and means a viscosity of 50 mPa·s or more. That is, a gel-like substance or the like that has extremely high viscosity and is difficult to discharge from the nozzle N of the inkjet head 1 is not expected. However, the boundary between high viscosity and non-high viscosity is not necessarily limited to this value. In addition, the high-viscosity ink may include ink containing particles that do not dissolve in a solvent, for example, pigment ink. The ink referred to herein is not limited to a color material for recording an image. The ink may include a liquid that solidifies to form a film, a conductor that forms wiring or the like, a functional member such as an adhesive, and the like.

First, a structure corresponding to the viscosity will be described.

The ink is represented by viscosity η and density ρ. The inkjet head 1 has a resonance frequency f of pressure fluctuation related to the ink pushed out from the nozzle N. One-half of the reciprocal of the resonance frequency f, that is, the length of a half-cycle of the pressure fluctuation, is referred to as the Acoustic Length (AL). The nozzle N has an opening diameter, that is, a nozzle diameter φ. Note that the nozzle N may have a tapered shape. The nozzle opening may be non-circular, in which case the size of the nozzle N is represented by the hydraulic diameter instead of the nozzle diameter. The non-circular shape may include an elliptical shape, a rectangular shape, any other polygonal shape, and a polygonal shape with rounded corners. In a case where the ink having a length L₁ runs out from the opening of the nozzle N by one pressurization of the ink, the mass M of the run-out ink is πφ²ρL₁/4. The force Fi that the ink receives is expressed as Fi=Mωv. The angular frequency ω=2πf. v is a movement speed of the ink liquid level inside and outside the nozzle N. Therefore, the force Fi that the ink receives is obtained by Expression 1.

Fi=2π²fφ²ρL₁v/4 (Equation 1)

The force Fi that the ink receives corresponds to the inertial force of the ink.

The ink having the mass M attempts to move in the discharge direction due to inertia in accordance with the movement speed v of the liquid surface (meniscus) of the ink inside the nozzle N corresponding to the pressurization of the ink. On the other hand, the ink having the mass M receives viscous resistance corresponding to the movement speed v of the liquid surface and is suppressed from being discharged from the nozzle N. The viscous resistance is determined according to the shear stress τ of the ink. The shear stress τ is expressed as τ=η·v/dy, where v is the movement speed of the liquid surface of the ink, and η is the viscosity of the ink. The movement speed v is an average movement speed, and y is a direction perpendicular to the axis of the nozzle N. Therefore, τ=η·v/(φ/4). The length of an ink column of an ink portion to be separated as a droplet is defined as L₂. Thus, the front-side area S₂ of the ink column is S₂=πφL₂. Therefore, the viscous resistance Fr is Fr=τ·S₂=4πηL₂v. Of these, the viscous resistance coefficient R is expressed by the following Expression 2.

R=4πηL₂ (Expression 2)

A ratio Fi/Fr=Mω/R between the viscous resistance Fr and the force Fi that the ink receives is a Q value for resonance of the ink pushed out from the nozzle N. This Q value also corresponds to the ease with which the ink to be discharged is separated from the ink in the pressure chamber C. Therefore, this Q value is hereinafter referred to as a breakup Q value Qt.

From the above-described expression, the breakup Q value Qt is obtained by the following Expression 3.

Qt=(L₁/L₂)πfρφ²/(8η) (Expression 3)

Therefore, the breakup Q value Qt is proportional to the density ρ and the reciprocal of the viscosity η (1/n) of the ink. That is, as the viscosity η increases, the viscous resistance coefficient R also increases, and the breakup Q value Qt decreases. Therefore, the ink to be discharged is less likely to be separated from the ink in the pressure chamber C. As the density ρ increases, the inertia of the ink increases, and the breakup Q value increases. Therefore, the ink to be discharged is likely to be separated from the ink in the pressure chamber C.

The breakup Q value Qt increases as the nozzle diameter φ increases. Furthermore, the breakup Q value Qt increases as the resonance frequency f increases and the AL decreases. That is, the nozzle diameter φ of the inkjet head 1 that discharges high-viscosity ink should not be too small. In addition, as is well known, AL, that is, the resonance frequency f, depends on the structure of the ink channel including the pressure chamber C. The parameters of the structure include, for example, the length, sectional shape, sectional area, and bending. Therefore, the droplet can be made to be easily separated from the ink in the nozzle N by increasing the breakup Q value Qt by changing the structure of the ink channel so as to decrease AL or increase the resonance frequency f with respect to the initial structure. Note that the actual AL may be experimentally obtained from the above-described width at which the flight speed of a droplet is maximized in a case where the droplet is discharged while the width of a drive pulse, for example, the width of one contraction pulse, is changed. Alternatively, AL may be obtained analytically or by numerical calculation or the like from the designed structure.

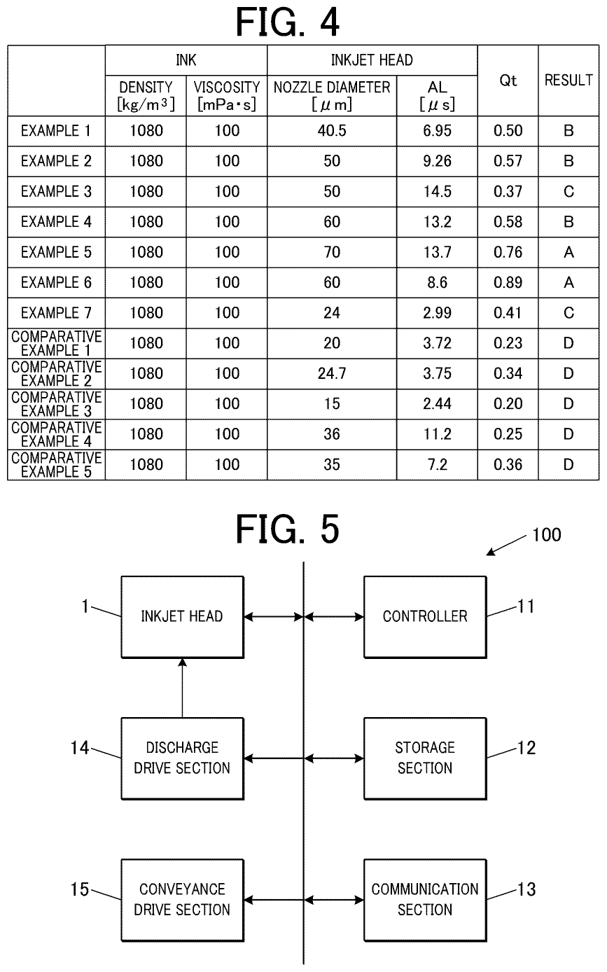

FIG. 4 is a table showing change in the breakup Q value Qt with respect to the nozzle diameter φ and the AL of the inkjet head 1 and the result of actual separation of ink droplets.

The density ρ of the ink to be discharged is 1,080 kg/m³ and the viscosity η thereof is 100 mPa·s. The breakup Q value Qt is calculated on the assumption that the ratio L₁/L₂ of the length L₁ and the length L₂ is 1.

As the separation result of the ink droplet, in examples, whether or not the ink is separated from the ink in the nozzle N and the length of the tail at the time of cutting are identified by photographing the ink at the time of ink discharge. In comparative examples, the length of the tail when the ink droplet is separated is obtained using numerical simulation.

In the case of example 3 in which the nozzle diameter φ=50 μm and AL=14.5, the breakup Q value Qt=0.37, and the ink droplet is barely separated from the ink in the nozzle N (evaluation C). Even in the cases (examples 1, 2 and 7) where the nozzle diameter φ is equal to or smaller than 50 μm, when AL is small in accordance with a decrease in the nozzle diameter φ, the breakup Q value Qt increases as a whole similarly to the case (example 4) in which the nozzle diameter φ is larger than 50 μm.

Even in the case (example 7) in which the nozzle diameter φ is 24 μm, the ink droplet can be separated from the ink in the nozzle N by AL being decreased to 8.6 (evaluation C). Even in this case, the nozzle diameter φ is preferably 40 μm or more. When the breakup Q value Qt≥0.50 or around, the ink droplet is appropriately separated from the ink in the nozzle N (evaluation B). When the breakup Q value Qt further increases, and in particular, the breakup Q value Qt≥0.76 (examples 5 and 6), the ink droplet is well separated without the tail becoming unnecessarily long (evaluation A).

On the other hand, in the comparative examples 1 to 5, the nozzle diameter φ is small, and the breakup Q value Qt is also as small as 0.36 or less. In these cases, even when the values of the nozzle diameter φ and AL are changed while the ratio thereof is maintained, the ink droplet is not appropriately separated (evaluation D).

FIG. 5 is a block diagram showing a functional configuration of an inkjet recording apparatus 100 including the inkjet head 1.

The inkjet recording apparatus 100 includes, in addition to the inkjet head 1, a controller 11, a storage section 12, a communication section 13, an discharge drive section 14, and a conveyance drive section 15.

The controller 11 includes a hardware processor such as a central processor unit (CPU). The controller 11 comprehensively controls the operation of the inkjet recording apparatus 100. Objects to be controlled by the controller 11 include an image recording operation using the inkjet head 1.

The storage section 12 includes a random access memory (RAM) and a nonvolatile memory. The RAM provides a working memory space for the hardware processor and stores temporary data. The storage section 12 includes a large-capacity RAM and stores image data to be recorded by operation of the inkjet head 1. The nonvolatile memory stores a control program, setting data, and the like. The nonvolatile memory also stores image data that is acquired from the outside and for which the image recording operation has not been completed. The nonvolatile memory is, for example, a flash memory, but is not limited thereto. The nonvolatile memory may include a hard disk drive (HDD).

The communication section 13 controls communication with an external device. The communication section 13 controls transmission and reception of data in accordance with, for example, a communication protocol for a local area network (LAN). The data to be received includes the image data to be recorded and the like. The communication section 13 may include a connection terminal such as a universal serial bus (USB). Alternatively, the communication section 13 may include a connection slot for an SD card or the like.

The discharge drive section 14 identifies the presence or absence of ink discharge from each nozzle at each timing in accordance with the image data to be recorded. The discharge drive section 14 outputs a drive signal corresponding to the presence or absence of ink discharge to the electrodes of the piezoelectric member E corresponding to each pressure chamber C of the inkjet head 1. A voltage is applied to the piezoelectric member E by the voltage supply to the electrodes.

The conveyance drive section 15 moves a recording medium before image recording to a position facing the inkjet head 1, and discharges the recording medium after image recording from the position facing the inkjet head 1. The conveyance drive section 15 moves the recording medium with respect to the inkjet head 1 and changes the landing position of the ink to be discharged from the inkjet head 1 with the passage of time. Note that when the inkjet head 1 records an image by a scanning method, the inkjet recording apparatus 100 may move the inkjet head 1 with respect to the recording medium.

A method of discharging ink from each nozzle N of the inkjet head 1 in the inkjet recording apparatus 100 will be described.

As described above, when the voltage is applied to the piezoelectric member E in accordance with the waveform pattern of the drive signal, the piezoelectric member E deforms in accordance with the waveform pattern. The waveform pattern is a combination of pulse-like voltage waveforms (voltage pulses). The pressure chamber C expands and contracts in accordance with the deformation of the piezoelectric member E in accordance with a rapid voltage change, and thus a pressure change is applied to the ink. Due to a motion generated in the ink in a direction along the axis of the nozzle N by a difference between the ink pressure and an atmospheric pressure outside the nozzle N, the pressure change is converted into kinetic energy.

It is preferable that the drive signal has a waveform pattern in which kinetic energy, that is, the flight speed of ink droplet, is efficiently obtained compared to power consumption corresponding to the output of the drive signal. The fact that the flight speed is relatively slow with the same drive signal indicates that the deformation of the piezoelectric member E is not efficiently converted into the kinetic energy of the ink. A slight decrease in the flight speed can be covered by an increase in the amplitude of the drive signal. On the other hand, as the amplitude increases, the power consumption increases. Therefore, a waveform pattern is set in which the flight speed is not significantly reduced as compared with the maximum flight speed obtained with a drive signal having a certain amplitude.

Depending on the waveform pattern, even if the flight speed of the main droplet at the head of the droplet is sufficient, the tail portion extending backward from the main droplet may not have the same speed as the main droplet, and in particular, may have a lower speed than the main droplet. Such non-uniformity of the speed may cause the discharged ink droplet to have a long tail or the tail to be finely separated into microdroplets (satellites). Therefore, a waveform pattern in which the length of the tail is not excessively long is preferable.

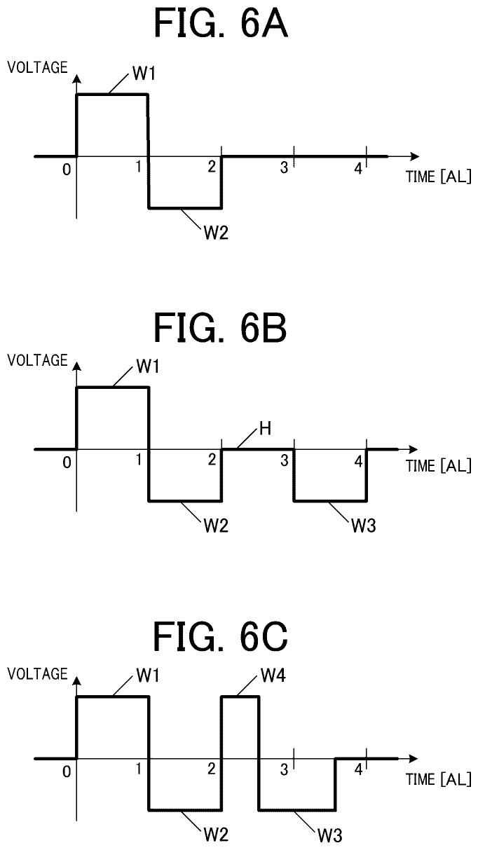

FIG. 6A to FIG. 6C show examples of the waveform pattern of the drive signal to be applied to the piezoelectric member E at the time of ink discharge. The inkjet recording apparatus 100 of the present embodiment reduces the pressure of the ink by expanding the pressure chamber C with a positive voltage, and increases the pressure of the ink by contracting the pressure chamber C with a negative voltage.

The waveform pattern of a first drive signal shown in FIG. 6A is a simple pull-strike waveform that expands and then contracts the pressure chamber C. The voltage pulses constituting this waveform pattern are rectangular pulses that change substantially discontinuously from a reference voltage to positive and negative voltages, but not limited thereto. They may be trapezoidal pulses or the like in which the voltage continuously changes with a certain time width.

The width of a first pulse W1 in which the voltage is positive, that is, the width of an expansion pulse, and the width of a second pulse W2 in which the voltage is negative, that is, the width of a contraction pulse, are each 1 AL, for example. Accordingly, it is possible to switch the ink from a depressurized state to a pressurized state substantially in synchronization with the resonance for the discharge of the ink, that is, the change in pressure. However, the width of each pulse may be different from the above.

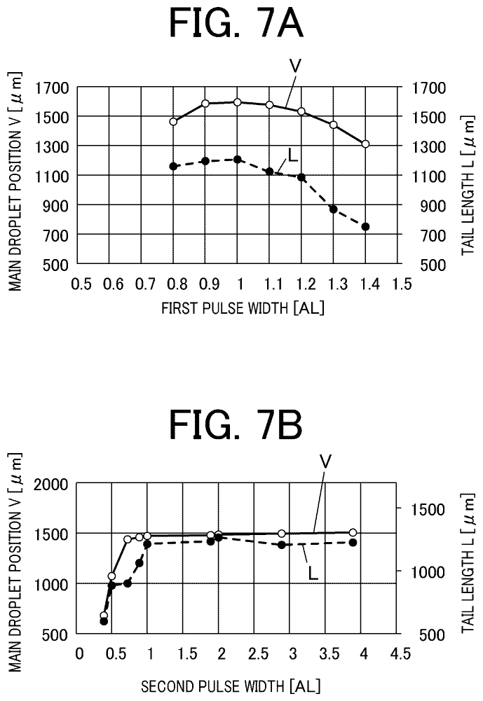

FIG. 7A and FIG. 7B show, in a waveform pattern of a first drive signal, the position V of the main droplet and the length L of the tail extending from the main droplet when a certain time has elapsed from the start of the drive signal, with respect to the widths of the first pulse W1 and the second pulse W2. The position V of the main droplet is indicated by a solid line and white circles with respect to the pulse width. The length L of the tail is indicated by a broken line and black circles with respect to the pulse width.

FIG. 7A shows a measurement result in a case where the width of the first pulse is changed in the vicinity of the 1 AL in a state in which the width of the second pulse W2 is fixed at 1 AL.

The position V of the main droplet corresponds to the speed of the main droplet. That is, the farther the position of the main droplet is, the higher the flight speed of the droplet is. According to FIG. 7A, it is found that, with a case as a reference where the width of the first pulse W1 is 1 AL, the flight speed decreases as the width deviates from 1.00 AL. When the flight speed is slow, the droplet is influenced by wind or the like between the opening surface and the landing surface, and landing accuracy is influenced. In addition, the landing position is shifted from the originally expected position, which leads to deterioration in image quality. Therefore, it is not preferable that the width of the first pulse W1 is greater than 1.30 AL. On the other hand, if the length L of the tail is great as compared with the position V of the main droplet, a width is generated in the landing position within the droplet, which leads to deterioration in image quality. That is, it is preferable that the tail of the ink droplet is short within a range in which the flight speed is not largely reduced. In other words, the ratio L/V of the length L of the tail and the position V of the main droplet is preferably small. The length L of the tail becomes shorter when the width of the first pulse W1 is greater than 1.00 AL. Therefore, the width of the first pulse W1 is preferably in a range from 1.10 AL in which the length L of the tail decreases to 1.30 AL in which the decrease in the position V is small, inclusive.

FIG. 7B shows a measurement result in a case where the width of the second pulse W2 is changed in the vicinity of 1 AL in a state in which the width of the first pulse W1 is fixed at 1.00 AL.

As long as the second pulse W2 is equal to or more than 0.72 AL, the position V of the main droplet, that is, the flight speed of the main droplet, hardly changes even if the width of the second pulse W2 becomes more. On the other hand, the length L of the tail decreases when the second pulse W2 is equal to or smaller than 0.89 AL. That is, a relatively small L/V is obtained when the width of the second pulse W2 is in the range of 0.72 AL to 0.89 AL. Therefore, the width of the second pulse W2 is preferably in the range of 0.72 AL to 0.89 AL inclusive, in which the flight speed is not significantly reduced and the length L of the tail can be shortened.

In the waveform pattern of a second drive signal shown in FIG. 6B, the period in which the ink is pressurized is divided into two. The width of the first pulse W1, which is a positive-voltage expansion pulse, is 1.00 AL, as with the above. Between the second pulse W2 that is the first negative voltage pulse and the third pulse W3 that is the second negative voltage pulse, a pause period H that is a period of the reference voltage is positioned. The width of the second pulse W2, the pause period H, and the width of the third pulse W3 are each, for example, about 1 AL. In particular, the width of the second pulse W2 and the width of the pause period H can be made equal. Thus, the total width of the waveform pattern is about 4 AL.

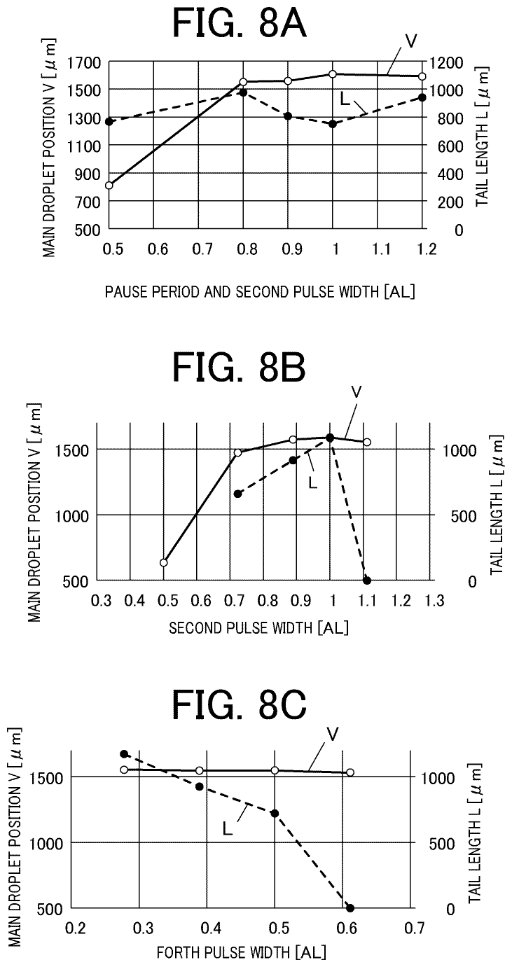

FIG. 8A shows, in a waveform pattern of a second drive signal, the position of the main droplet and the length of the tail extending from the main droplet when a certain time has elapsed from the start of the drive signal. FIG. 8A shows a measurement result in a case where, in a state in which the widths of the first pulse W1 and the third pulse W3 are fixed at 1.00 AL, the widths of the second pulse W2 and the pause period H are changed in the vicinity of 1 AL while being kept equal to each other.

It is found that when the second pulse W2 and the pause period H are 0.80 AL or more, the flight speed of the main droplet is sufficiently obtained and does not greatly change. Also, in this range, the length L of the tail does not increase significantly. Note that the length L of the tail of 1.20 AL is not preferable because it generates a satellite droplet separated from the main droplet. Therefore, in a case where the ink is discharged by the waveform pattern of the second drive signal, it is preferable that the widths of the second pulse W2 and the pause period H are equal to each other, and both of them are equal to or more than 0.80 AL and equal to or less than 1.00 AL.

In the waveform pattern of the third drive signal shown in FIG. 6C, a fourth pulse W4, which is a positive voltage pulse, is output instead of the pause period H of the reference voltage between the second pulse W2 and the third pulse W3, which are two negative voltage pulses in the waveform pattern of the second drive signal. The widths of the first pulse W1, the second pulse W2, and the third pulse W3 are each about 1 AL. The width of the fourth pulse W4 is shorter than the pause period H, and is about 0.5 AL here. Therefore, the total width of the waveform pattern of the third drive signal is about 3.5 AL. The expansion pulse that is the fourth pulse W4 produces the effect of “tail cutting” by effectively pulling back a portion of the pushed-out ink, the portion that is in the vicinity of the nozzle N and does not achieve a sufficient flight speed compared to the main droplet.

FIG. 8B and FIG. 8C show, in a waveform pattern of a third drive signal, the position V of the main droplet and the length L of the tail extending from the main droplet when a certain time has elapsed from the start of the drive signal. FIG. 8B shows a measurement result in a case where the widths of the first pulse W1 and the third pulse W3 are fixed at 1.00 AL, the width of the fourth pulse W4 is fixed at 0.50 AL, and the width of the second pulse W2, which is the first contraction pulse, is changed. FIG. 8C shows a measurement result in a case where the widths of the first pulse W1, the second pulse W2, and the third pulse W3 are fixed at 1.00 AL, and the width of the fourth pulse W4, which is the second expansion pulse, is changed.

As shown in FIG. 8B, when the width of the second pulse W2 is less than 0.72 AL, the position V of the main droplet, that is, the flight speed of the main droplet, greatly decreases. On the other hand, when the width is equal to or greater than 0.72 AL, the speed of the main droplet does not change greatly. The second pulse W2 also has an effect of offsetting the periodic pressure fluctuation generated by the first pulse W1. In this case too, when the width of the second pulse W2 is 1.10 AL, a satellite droplet is separated from the main droplet, which is undesirable. As described above, in order to increase the effect of tail cutting by the fourth pulse W4, the width of the second pulse W2 can be made to 1.00 AL or shorter, particularly shorter than 1.00 AL, so that the offsetting effect by the first pulse W1 does not become too large. Therefore, the width of the second pulse W2 is preferably greater than or equal to 0.72 AL and less than or equal to 1.00 AL.

As shown in FIG. 8C, the width of the fourth pulse W4 does not affect the flight speed of the main droplet. On the other hand, in the case where the width of the fourth pulse W4 is 0.39 AL or more, the length L of the tail can be made shorter as the width become larger. Provided that the fourth pulse W4 having a width of 0.61 is not preferable because separation of the satellite droplet from the main droplet occurs. Therefore, the width of the fourth pulse W4 is preferably greater than or equal to 0.39 AL and less than or equal to 0.50 AL.

As described above, the inkjet head 1 according to the present embodiment includes the nozzle N, the pressure chamber C communicating with the nozzle N, and the pressurizer including the piezoelectric member E and the electrodes and applying pressure fluctuation to the ink in the pressure chamber C. The inkjet head 1 has a structure in which when pressure fluctuation is applied by the pressurizer and the viscosity η of the ink running out from the nozzle N is 100 mPa·s and the density ρ is 1,080 kg·m⁻³, the breakage Q value Qt expressed as πfρφ²/(8η) using the nozzle diameter φ and the resonance frequency f is 0.37 or more with respect to the ink.

That is, the inkjet head 1 has a structure in which the tail of the discharged ink droplet is appropriately cut even when the ink has a high viscosity. According to the inkjet head 1 having such an appropriate structure, it is possible to stably discharge the high-viscosity ink without requiring complicated control. In addition, when the viscosity is high, it is difficult for the discharged ink to be well separated from the ink in the nozzle, and therefore microdroplets such as satellites are likely to be generated, and the flight of the ink is adversely affected. The inkjet head 1 can suppress generation of such microdroplets, and allows ink droplets to more stably fly and land.

The breakup Q value may be 0.5 or more. The inkjet head 1 can discharge the ink droplets collectively at an appropriate flight speed with higher accuracy.

The breakup Q value may be 0.76 or more. When the breakup Q value Qt is large to this extent, the inkjet head 1 can stably suppress generation of microdroplets, and allows ink droplets to land on a desired position(s) with accuracy.

The nozzle diameter φ may be 24 μm or more. When the nozzle diameter φ is too small, the cost for manufacturing the inkjet head 1 in which the necessary AL is obtained tends to increase. In addition, clogging with ink is likely to occur. The nozzle diameter φ of 24 μm or more enables the inkjet head 1 to easily and stably discharge ink.

The nozzle diameter φ may be 40 μm or more. When the nozzle diameter φ of the nozzle N to discharge the high-viscosity ink is large to this extent, the inkjet head 1 can suppress generation of satellites of the high-viscosity ink, and discharge ink droplets so as to accurately land at an appropriate landing position(s).

The pressurizer may include the piezoelectric member E that applies pressure fluctuation to the ink by deforming in a shear mode in response to application of voltage. The structure of the inkjet head 1 having the breakup Q value Qt of the present embodiment can be widely and easily used, including a piezoelectric member that deforms in a bending mode. In the shear mode, the drive wall of the actuator tends to be thick and hard, and thus the resonance frequency tends to increase. Therefore, the pressurizer deforming in the shear mode makes it easy to shorten AL. On the other hand, since the drive amplitude of the drive wall is increased, the drive voltage is easily decreased.

In the ink discharge method of the present embodiment, for the inkjet head 1, the drive pulse for causing the pressurizer to generate the pressure fluctuation in the ink is determined such that the flight speed of the ink droplet when the ink is discharged is equal to or higher than 4 m/s. As described above, the flight speed increases according to the amplitude of the drive pulse. In addition, by making the pulse width close to AL corresponding to the resonance frequency f of the drive pulse, the pressure fluctuation is efficiently converted into kinetic energy and a speed is obtained. Thus, when the flight speed is 4 m/s or more, the influence of the air resistance and the wind flow on the ink droplet is suppressed, and the ink droplet easily lands at a desired position.

Furthermore, in the ink discharge method, the interval between the opening surface of the nozzle and the landing surface of the ink to be discharged from the nozzle may be 2 mm or more at the time of ink discharge. In a case of ink landing at an interval wider than 1 mm or less that is a normal interval, the influence of microdroplets and long tails is likely to be great. On the other hand, a large amount of high-viscosity ink exists in a functional member or the like. An ink whose shape after being discharged and landing involves a three-dimensional structure, that is, which has a thickness, can be included in the high-viscosity ink. For discharging these kind of ink, a wide interval is required so that the opening surface and the landing surface do not come into contact with each other. The above-described ink discharge method can effectively determine the landing position with high accuracy in such cases. In addition, this ink discharge method can prevent microdroplets from adhering to unintended places.

The viscosity η of the ink to be discharged may be 50 mPa·s or more. The ink discharge method of the present embodiment can discharge ink with accuracy and land ink with accuracy even when the ink has a high viscosity, which is different from the reference viscosity η=100 mPa·s.

The ink to be discharged may contain particles that do not dissolve in a solvent. When the breakup Q value is determined under the above-described conditions, the nozzle diameter φ basically increases. Thus, the number of particles per unit length in the nozzle N is increased, thereby reducing the possibility that the particles are stochastically unevenly distributed. Therefore, the inkjet head 1 can perform stable ink discharge with small unevenness in the discharge speed.

The first drive signal includes the first pulse W1 to expand the pressure chamber C and the second pulse W2 to contract the pressure chamber C. The width of the first pulse W1 is not less than 1.10 times and not more than 1.30 times AL, and the width of the second pulse W2 is not less than 0.72 times and not more than 0.89 times AL.

The pulse width being about AL makes the ink to be pressurized substantially in accordance with the liquid level vibration of the ink in the nozzle N. Therefore, the drive pulse is efficiently converted into kinetic energy. In particular, in the first drive signal, the first pulse W1 is made slightly longer than AL, and the second pulse W2 is made slightly shorter than AL. In the ink discharge method in the range of this combination, the discharge speed of the droplet is not largely reduced, and the length of the satellite (tail) can be maintained to be short. Thus, the ink discharge method can efficiently discharge ink droplets and allow the droplets to land with high accuracy.

The second drive signal may include the first pulse W1 to expand the pressure chamber C, the second pulse W2 to contract the pressure chamber C, the third pulse W3 to contract the pressure chamber C again after the second pulse W2, and the pause period H positioned between the second pulse W2 and the third pulse W3 not to contract or expand the pressure chamber C. In this case, the widths of the second pulse W2 and the pause periods H are both not less than 0.8 times and not more than 1.0 times AL.

As described above, according to the second drive signal in which the third pulse W3 is added after the pause period H, the rear end of the discharged ink is appropriately pushed out again after the pause period H which corresponds to the liquid level vibration of the ink in the nozzle or is slightly shorter than this. Therefore, the ink discharge method with the second drive signal can suppress generation of a microdroplet(s) from the ink droplet to be discharged, and can suppress elongation of the tail from the main droplet.

The third drive signal includes the first pulse W1 to expand the pressure chamber C, the second pulse W2 to contract the pressure chamber C, the third pulse W3 to contract the pressure chamber C again after the second pulse W2, and the fourth pulse W4 positioned between the second pulse W2 and the third pulse W3 to expand the pressure chamber C. In this case, the width of the second pulse W2 is not less than 0.72 times and not more than 1.00 times AL, and the width of the fourth pulse W4 is not less than 0.39 times and not more than 0.50 times AL.

According to the third drive signal including the fourth pulse W4, which is the expansion pulse, the tail of the discharged ink droplet is pulled back by the fourth pulse W4. Accordingly, the droplet is easily separated from the ink in the nozzle N. Therefore, the fourth pulse W4 has a length to obtain the effect of performing pulling-back appropriately to the extent that the satellite droplet is not separated from the main droplet. Thus, the ink discharge method with the third drive signal suppresses elongation of the tail of the ink droplet to be discharged and, at the same time, suppresses generation of microdroplets. Therefore, in this ink discharge method, the landing positions of the ink are more appropriately aligned.

The inkjet recording apparatus 100 according to the present embodiment includes the inkjet head 1 described above and the controller 11 that causes the pressurizer to output the drive pulse in any of the ink discharge methods described above to apply it to the ink. The inkjet recording apparatus 100 can appropriately tail off, in particular, the high-viscosity ink to suppress generation of microdroplets, thereby discharging the ink easily and stably.

Note that the above embodiment is merely an example, and various changes can be made.

For example, the nozzle diameter φ may not be limited to the above-described range. It may be appropriately determined in accordance with the use and required resolution of the inkjet head 1, the manufacturing technology and cost of the inkjet head 1, the temperature dependence of viscosity, and so forth too.

Further, the flight speed of the ink droplet may not be 4 m/s or more. It is sufficient as long as the ink droplet can stably fly and land.

The interval between the nozzle opening surface and the landing surface may not be 2 mm or more. The inkjet head 1 may have a normal interval from a medium, and the inkjet recording apparatus 100 may record a two-dimensional image or the like on the recording medium. In this case, it is preferable that the ink droplet is separated from the ink in the nozzle N more quickly according to the interval.

The piezoelectric member E may not be positioned so as to deform in the shear mode. The piezoelectric member E may be positioned, for example, so as to deform in the bending mode. Further, the shape of the pressure chamber C may be a shape other than the exemplified shape.

In the above, the nozzle N has a cylindrical shape, but is not limited thereto. The nozzle N may have a tapered shape. In this case, a value of a portion having the smallest diameter may be used as the nozzle diameter φ.

In the above embodiment, the piezoelectric member E deforms by a voltage applied to the piezoelectric member E, and in response to this, pressure fluctuation is applied to the ink in the pressure chamber C, but this is not a limitation. A member that deforms in accordance with a physical quantity other than voltage, such as a magnetostrictive element, may be used. In addition, the nozzles N are not limited to being arranged in a one-dimensional array in which the nozzles are horizontally arranged. They may be arranged in a two-dimensional plane. Besides, the structure of the inkjet head 1 may be different from the structure described above.

The drive signal is not limited to the waveform patterns exemplified above. The ink may be discharged with a drive signal having another waveform pattern. Further, even in the exemplified waveform pattern(s), the width of each voltage pulse may be different from the above. A drive signal having an appropriate waveform pattern may be selected in accordance with characteristics of ink and surrounding environments, for example, temperature and humidity.

Furthermore, the inkjet head 1 may not be distributed integrally with the inkjet recording apparatus 100. A user may purchase or rent (lease) the inkjet head 1 independently from the inkjet recording apparatus 100. The purchase or rent includes replacement of an existing inkjet head 1 in a certain inkjet recording apparatus 100.

Besides, the specific configuration, content and procedure of the processing operation and the like described in the above embodiment can be appropriately modified without departing from the scope of the present disclosure. The scope of the present invention includes the scope of the invention described in claims and the scope of equivalents thereof.

### INDUSTRIAL APPLICABILITY

The present disclosure is applicable to an inkjet head, an ink discharge method, and an inkjet recording apparatus.

### REFERENCE SIGNS LIST

1 inkjet head
11 controller
12 storage section
13 communication section
14 discharge drive section
15 conveyance drive section
100 inkjet recording apparatus
C pressure chamber
Dm main droplet
E piezoelectric member
F common channel
N nozzle
Pc cover plate
Pn nozzle plate
S microdroplet
T tail

1. An inkjet head comprising:
a nozzle;
a pressure chamber that communicates with the nozzle; and
a pressurizer that applies a pressure fluctuation to an ink in the pressure chamber,
wherein the inkjet head has a structure in which in a case where a viscosity η of the ink that runs out from the nozzle by the pressurizer applying the pressure fluctuation thereto is 100 mPa·s, and a density ρ thereof is 1,080 kg·m⁻³, a breakup Q value that is expressed as πfρφ²/(8η) using a nozzle diameter φ and a resonant frequency f is 0.37 or more with respect to the ink.

2. The inkjet head according to claim 1, wherein the breakup Q value is 0.5 or more.

3. The inkjet head according to claim 1, wherein the breakup Q value is 0.76 or more.

4. The inkjet head according to claim 1, wherein the nozzle diameter is 24 μm or more.

5. The inkjet head according to claim 1, wherein the nozzle diameter is 40 μm or more.

6. The inkjet head according to claim 1, wherein the pressurizer includes an electromechanical conversion element that deforms in a shear mode in response to application of a voltage, thereby applying the pressure fluctuation.

7. An inkjet discharge method for the inkjet head according to claim 1, wherein a drive pulse to cause the pressurizer to generate the pressure fluctuation in the ink is determined such that a flight speed of an ink droplet when the ink is discharged is 4 m/s or more.

8. The ink discharge method according to claim 7, wherein an interval between an opening surface of the nozzle and a landing surface of the ink that is discharged from the nozzle is 2 mm or more when the ink is discharged.

9. The ink discharge method according to claim 7, wherein the viscosity of the ink that is discharged is 50 mPa·s or more.

10. The ink discharge method according to claim 7, wherein the ink that is discharged contains a particle that does not dissolve in a solvent.

11. The ink discharge method according to claim 7,
wherein the drive pulse includes a first pulse to expand the pressure chamber and a second pulse to contract the pressure chamber, and
wherein a width of the first pulse is not less than 1.10 times and not more than 1.30 times an AL (Acoustic Length), and a width of the second pulse is not less than 0.72 times and not more than 0.89 times the AL.

12. The ink discharge method according to claim 7,
wherein the drive pulse includes a first pulse to expand the pressure chamber, a second pulse to contract the pressure chamber, a third pulse to contract the pressure chamber again after the second pulse, and a pause period positioned between the second pulse and the third pulse not to contract or expand the pressure chamber, and
wherein a width of the second pulse and a width of the pause period are both not less than 0.80 times and not more than 1.00 times an AL.

13. The ink discharge method according to claim 7,
wherein the drive pulse includes a first pulse to expand the pressure chamber, a second pulse to contract the pressure chamber, a third pulse to contract the pressure chamber again after the second pulse, and a fourth pulse positioned between the second pulse and the third pulse to expand the pressure chamber, and
wherein a width of the second pulse is not less than 0.72 times and not more than 1.00 times an AL, and a width of the fourth pulse is not less than 0.39 times and not more than 0.50 times the AL.

14. An inkjet recording apparatus comprising:
the inkjet head according to claim 1; and
a controller that causes the pressurizer to output the drive pulse in an ink discharge method to apply the pressure fluctuation to the ink, wherein a drive pulse to cause the pressurizer to generate the pressure fluctuation in the ink is determined such that a flight speed of an ink droplet when the ink is discharged is 4 m/s or more.
